(19) United States
(12) Patent Application Publication
(10) Pub. No.: US 2023/0060678 A1
(43) Pub. Date: Mar. 2, 2023

(54) VERIFICATION OF INPUT FILES FOR PRINTED DOCUMENTS

(71) Applicant: Hewlett-Packard Development Company, L.P., Spring, TX (US)

(72) Inventors: Barnaby NETHERWOOD, London (GB); Brad Lee Baker, Boise, ID (US); Pietro Maltese, London (GB); James Frederick Fordemwalt, Boise, ID (US); Uri Weiner, Nes Ziona (IL); Nir Gilon, Nes Ziona (IL)

(73) Assignee: Hewlett-Packard Development Company, L.P., Spring, TX (US)

(21) Appl. No.: 17/410,884

(22) Filed: Aug. 24, 2021

(51) Int. Cl. G06F 3/12

(52) U.S. Cl. CPC G06F 3/1234; G06F 3/1267; G06F 3/1265; G06F 3/1204

(57) ABSTRACT

According to examples, an apparatus may include a processor and a memory on which are stored computer-readable instructions that, when executed by the processor, may cause the processor to receive an input file and validate the input file for render errors. Based on a determination that the input file does not include the render errors, the processor may determine whether the input file passes a pre-flight analysis. Based on a determination that the input file has passed the pre-flight analysis, the processor may determine whether a specification of the input file matches an output specification for a printed document. Based on a determination that the specification of the input file corresponds to the output specification, the processor may output the input file as a verified input file for the printed document.

### BACKGROUND

During printing processes, digital documents may be ingested to verify that the digital documents are ready to print. The digital documents may include various types of errors, which may delay printing.

### BRIEF DESCRIPTION OF THE DRAWINGS

Features of the present disclosure are illustrated by way of example and not limited in the following figure(s), in which like numerals indicate like elements, in which:

FIG. 1 depicts a block diagram of an example apparatus that may validate an input file, perform a pre-flight analysis on the input file, perform a specification check on the input file, and output a verified output file based on the input file;

FIG. 2 depicts a block diagram of an example system within which the example apparatus depicted in FIG. 1 may be implemented;

FIG. 3 depicts a flow diagram of an example method for performing file validation for an input file, which may include performing error detection, re-distillation, and re-validation of the input file;

FIG. 4 depicts a flow diagram of an example method for performing pre-flight analysis for an input file, which may include detecting errors, applying fixes based on detected errors, and verifying the fixed input file using a file compare;

FIG. 5 depicts a flow diagram of an example method for performing a specification check for an input file, which may include determining whether a specification of the input file matches an output specification and correcting the specification of the input file;

FIG. 6 depicts a flow diagram of an example method for verifying an input file for a printed document, which may include validating the input file for render errors, determining whether the input file passes a pre-flight analysis, determining whether a specification of the input file matches an output specification for a printed document, and outputting the input file as a verified output file for the printed document; and

FIG. 7 depicts a block diagram of an example non-transitory computer-readable medium that may have stored thereon computer-readable instructions to verify a portable document format (PDF) file to output a verified PDF file, to validate the PDF file for render errors, determine whether the PDF file passes a PDF pre-flight analysis, and determine whether a specification of the PDF file matches an output specification.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Generally, digital content for printing, such as for book publishing, may be ingested to ensure that the digital content is suitable for printing. Digital content ingestion may include fixing, amending, and/or tweaking the digital content, such as digital books, for various types of errors prior to downstream processes, such as being rasterized downstream. Concerns associated with implementations for digital content ingestion may be that, in some instances, human intervention may be used to prepare the files to print, which may result in relatively large costs, particularly as the number of digital content for review increases.

Disclosed herein are apparatuses, systems, methods, and computer-readable media in which a processor may automate the digital content ingestion to prepare the digital content for printing, such as PDF documents, which may increase efficiencies in validating the digital files as well as reduce potential issues in later processes, such as in rasterizing downstream. In some examples, the automated digital content ingestion may include file validation for render errors, pre-flighting and applying fixes, and performing specification checks to conform to specification of a printed document.

In some examples, a processor may receive an input file and may validate the input file for render errors. The processor may determine whether the input file passes a pre-flight analysis. Based on a determination that the input file has passed the pre-flight analysis, the processor may determine whether a specification of the input file matches an output specification. Based on a determination that the specification of the input file corresponds to the output specification, the processor may output the input file as a verified output file.

By enabling automated verification of input files as disclosed herein, which may include file validation, pre-flighting, and specification checking, the processor may reduce errors in digital files for print production, for instance, by correcting for errors prior to rasterizing downstream, which may in turn reduce associated costs in both manpower for manual human verification of the input files, as well as reduce consumption of computing resources due to the delays.

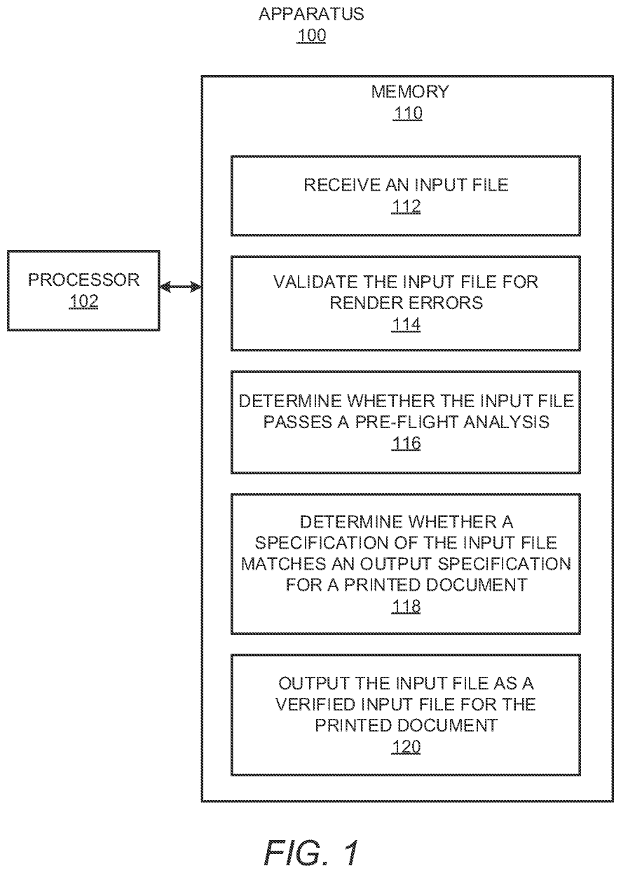

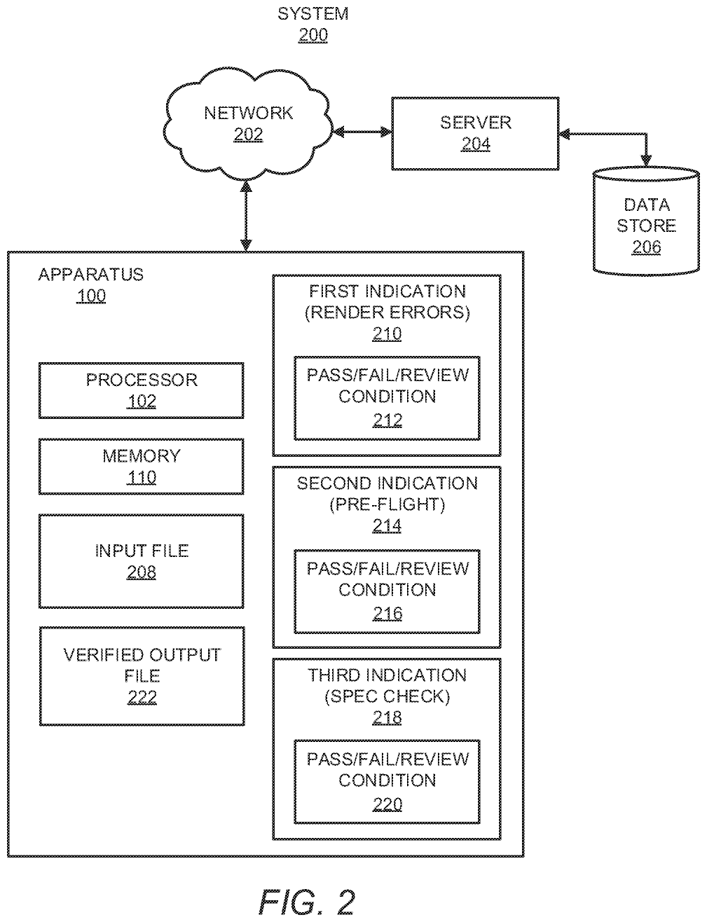

Reference is made to FIGS. 1 and 2. FIG. 1 depicts a block diagram of an example apparatus 100 that may validate an input file, perform a pre-flight analysis on the input file, perform a specification check on the input file, and output a verified output file based on the input file. FIG. 2 depicts a block diagram of an example system 200 within which the example apparatus 100 depicted in FIG. 1 may be implemented. It should be understood that the apparatus 100 depicted in FIG. 1 and the system 200 depicted in FIG. 2 may include additional features and that some of the features described herein may be removed and/or modified without departing from the scopes of the apparatus 100 and/or the system 200.

In some examples, the apparatus 100 may be implemented in a computing device, such as a server, a scanner, a printer (such as an inkjet printer, a laser printer, a photo printer, or the like), and/or the like. As shown, the apparatus 100 may include a processor 102 and a non-transitory computer-readable medium, e.g., a memory 110. The processor 102 may be a semiconductor-based microprocessor, a central processing unit (CPU), an application specific integrated circuit (ASIC), a field-programmable gate array (FPGA), and/or other hardware device. Although the apparatus 100 is depicted as having a single processor 102, it should be understood that the apparatus 100 may include additional processors and/or cores without departing from a scope of the apparatus 100 and/or system 200. In this regard, references to a single processor 102 as well as to a single memory 110 may be understood to additionally or alternatively pertain to multiple processors 102 and/or multiple memories 110. As depicted in FIG. 2, the apparatus 100 may be implemented in a system 200, which may include a server 204, which may be connected to a data store 206, with which the apparatus 100 may be in communication via a network 202.

The memory 110 may be an electronic, magnetic, optical, or other physical storage device that contains or stores executable instructions. The memory 110 may be, for example, Read-Only Memory (ROM), flash memory, solid state drive, Random-Access memory (RAM), an Electrically Erasable Programmable Read-Only Memory (EEPROM), a storage device, an optical disc, or the like. The memory 110 may be a non-transitory computer-readable medium. The term “non-transitory” does not encompass transitory propagating signals.

As shown in FIG. 1, the processor 102 may execute instructions 112-120 to verify digital content for file ingestion. The instructions 112-120 may be computer-readable instructions, e.g., non-transitory computer-readable instructions. In other examples, the apparatus 100 may include hardware logic blocks or a combination of instructions and hardware logic blocks to implement or execute functions corresponding to the instructions 112-120.

The processor 102 may fetch, decode, and execute the instructions 112 to receive an input file 208. The input file 208 may be digital content for printing, such as a book, a catalog, a periodical, and/or the like. In some examples, the input file 208 may have a predetermined file format, such as a PDF format, a joint photographic experts group (JPEG) format, tag image file format (TIFF) format, and/or the like.

The processor 102 may fetch, decode, and execute the instructions 114 to validate the input file 208 for render errors. In response to results of the file validation, the processor 102 may output a first indication 210, which may include a condition 212 or a result of the validation, which may indicate a pass, a fail, or a review condition. The pass condition may indicate that the input file 208 has passed the file validation, the fail condition may indicate that the input file 208 has failed the file validation, and the review condition may indicate that the input file 208 has passed the file validation, but that potential issues may exist and/or may indicate a recommendation for human intervention to review the input file 208.

In some examples, to validate the input file 208, the processor 102 may determine whether the input file 208 includes a render error, which may be based on a file type, a structure of a file format, a predetermined rule or criteria such as whether the whether the input file 208 can be opened and worked on, and/or the like. By way of particular example and for purposes of illustration, in a case where the input file 208 is a PDF file, the processor 102 determine whether the PDF file may be opened, and may determine whether a structure of the input file 208 is consistent with specifications of the corresponding PDF format, in order to detect malformed or improperly configured input files 208.

In some examples, during the file validation, based on a determination that the input file 208 has an invalid file type, such as a file type that may not be supported or one that may not be compatible, the processor 102 may output the first indication 210 having a condition 212 set to a failed condition, and based on a determination that the input file 208 does not include render errors, the processor 102 may output the first indication 210 having a condition 212 set to a pass condition. In some examples, prior to determining that the input file 208 has passed the file validation, the processor 102 may perform additional checks, such as a complexity check to determine whether a complexity of the contents of the input file 208 is below a predetermined threshold, a check to determine whether the input file 208 has been re-distilled, in which case the processor 102 may output the first indication having a review condition to recommend human review of the re-distilled input file 208, and/or the like. In some examples, the complexity check may include a determination of an amount of time to rasterize the input file 208 relative to a predetermined threshold, and based on the determined amount of time being greater than the predetermined threshold, the processor 102 may output an indication to the user, for instance, to alert the user to review the input file 208. In some examples, the complexity of the input file 208 may be due to, for instance, a number of different fonts, colors, layers, and/or the like, included in the input file 208.

In some examples, based on a determination that a render error for the input file 208 exists, the processor 102 may determine whether the detected render errors include predetermined errors classified as recoverable errors. Based on a determination that an error is a recoverable error, the processor 102 may re-distill the input file 208, to convert the input file 208 from a page description language format, such as a PostScript format, to a portable document format (PDF). In some examples, re-distilling the input file 208 may include converting a format of the input file 208 from a first format to a second format in order to repack the input file 208. Continuing with the example in which the input file 208 is a PDF file, the processor 102 may re-distill the PDF file by converting the input file 208 from a PDF format to a PostScript format, then converting the input file 208 from the PostScript format to the PDF format in order to repack the PDF file.

In some examples, the processor 102 may re-validate the re-distilled input file 208 for the render errors. In some examples, based on the re-distilled input file 208 being successfully re-validated to not include render errors, the processor 102 may output the re-validated input file 208 for a pre-flight analysis. In some examples, based on the re-distilled input file 208 not being successfully re-validated, the processor 102 may output the first indication 210 for the input file 208 with a fail or review condition, which may include an error message, an indication to a user to review the input file 208, and/or the like.

The processor 102 may fetch, decode, and execute the instructions 116 to determine whether the input file 208 passes a pre-flight analysis. In some examples, the processor 102 may perform the pre-flight analysis based on a determination that the input file 208 does not include render errors, for instance, based on a re-distilled input file 208 that has been fixed to address recoverable errors and which has passed the file validation.

Based on a result of the pre-flight analysis, the processor 102 may output a second indication 214, which may include a condition 216 based on the pre-flight analysis, such as a pass, a fail, or a review condition. In this regard, the pass condition may indicate that the input file 208 has passed the pre-flight analysis, the fail condition may indicate that the input file 208 has failed the pre-flight analysis, and the review condition may indicate that the input file 208 has passed the pre-flight analysis, but potential issues may exist and/or may indicate a recommendation for human intervention to review the input file 208.

As used herein, a pre-flight analysis, or pre-flighting, may be a process to confirm that digital files for printing processes are all present, valid, correctly formatted, of the correct type, and/or the like, in order to prepare the digital files for downstream printing processes. In some examples, during the pre-flight analysis, the processor 102 may confirm and verify colors, fonts, transparency layers, image resolutions, PDF versions, and/or the like, which may be included in the input file 208.

Based on a determination that the input file 208 has failed the pre-flight analysis, processor 102 may determine whether any of the detected pre-flight errors are known errors. In some examples, the pre-flight analysis may correlate with a predetermined file format profile and the known errors for the file format profile may have correlated fixes to address the known errors. The processor 102 apply a fix to the input file 208 based on the determined known errors identified during the pre-flight analysis. Continuing with the example in which the input file 208 is a PDF file, the processor 102 may determine during the pre-flight analysis that certain fonts embedded in the PDF file do not match a pre-flight profile associated with the pre-flight analysis, and in such instances, the processor 102 may apply a fix to correct the fonts in the PDF file. Once the fix is applied, the processor 102 may determine whether the fixed input file 208 passes a second pre-flight analysis. In some examples, the pre-flight analysis, which is initially applied to the input file 208, and the second pre-flight analysis may be based on the same file format profile, such as a specific PDF profile. In some examples, the processor 102 may iteratively apply fixes and the pre-flight analysis a predetermined number of iterations until the input file 208 passes the pre-flight analysis, or the processor 102 may exit the pre-flight analysis when the pre-flight analysis fails after the predetermined number of iterations.

In some examples, based on a determination that the input file 208 has passed the second pre-flight analysis, the processor 102 may perform a file comparison between the input file 208 with the applied fix and the input file 208 without the fix. In some examples, the processor 102 may convert pages of the input file 208 into images, then the processor 102 may compare the image of the input file 208 based on a pixel-by-pixel comparison between an image in the input file 208 that includes the fix and an image in the input file 208 without the fix. In some examples, the pixel-by-pixel comparison may be performed at a predetermined pixel resolution, for instance, at a one pixel resolution, or the like.

Based on a determination that the image in the input file 208 that includes the fix matches the image in the input file 208 without the fix, the processor 102 may output the second indication 214 including the condition 216 to indicate a pass condition and the processor 102 may output the input file 208 as a pre-flighted input file.

The processor 102 may fetch, decode, and execute the instructions 116 to determine whether specifications of an input file, such as the input file 208 that has pass the pre-flight analysis, matches an output specification for a printed document, or outbound specifications. Based on a result of the determined specification of the input file 208 corresponds to the output specification, the processor 102 may generate a third indication 218, which may include a condition 220 to indicate a pass, a fail, or a review condition for the specification of the input file 208. The pass condition may indicate that the input file 208 has passed the specification check, the fail condition may indicate that the input file 208 has failed the specification check, and the review condition may indicate that the input file 208 has passed the specification check, but that potential issues may exist and/or may indicate a recommendation for human intervention to review the input file 208.

In some examples, the inbound specifications for the input file 208 and the outbound specifications for the printed document may correlate to parameters for a shape, a size, and/or the like, of the printed document. In some examples, the processor 102 may determine whether a shape and/or a size of the input file 208 matches the output specification for the printed document. In some examples, the processor 102 may adjust the shape and/or the size of the input file 208 based on the inbound specifications, which may be obtained from metadata of the input file 208. Based on a determination that the shape and/or a size of the input file 208 does not match the output specification for the printed document, the processor 102 may adjust the shape and/or the size of the input file 208 to match the output specification based on a determination that the shape and/or a size of the input file 208 does not match the output specification for the printed document. The processor 102 may output the third indication 218 with a condition 220 to indicate a review condition, recommending a user review of the specification checked input file 208.

The processor 102 may fetch, decode, and execute the instructions 120 to output the input file 208 as a verified output file 222 for the printed document. In some examples, based on a determination that the specification of the input file 208 corresponds to the output specification, the processor 102 may output the specification checked input file 208 as the verified output file 222.

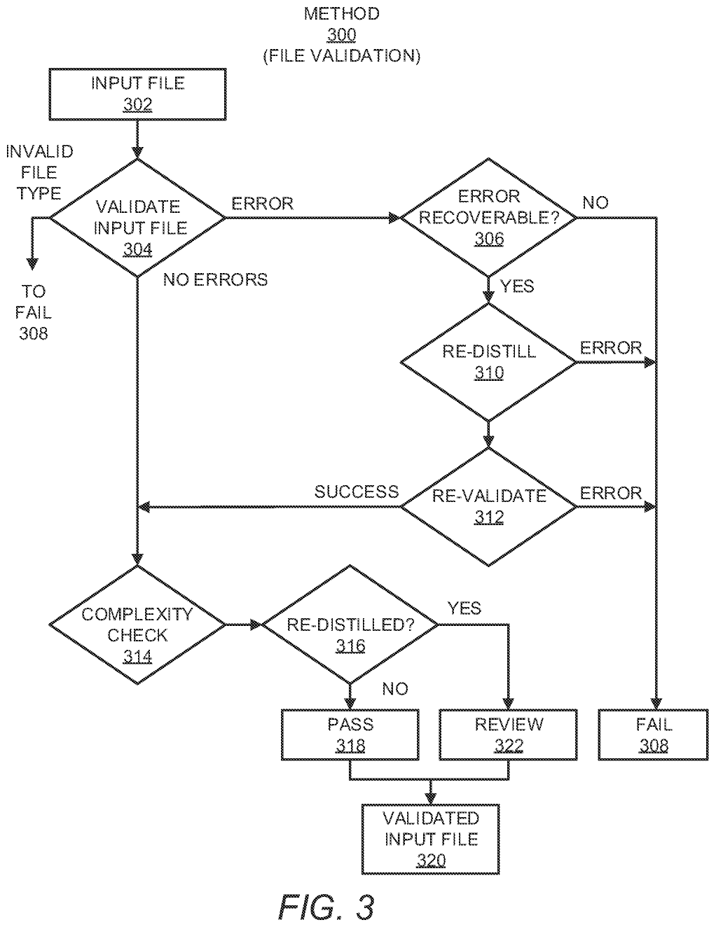

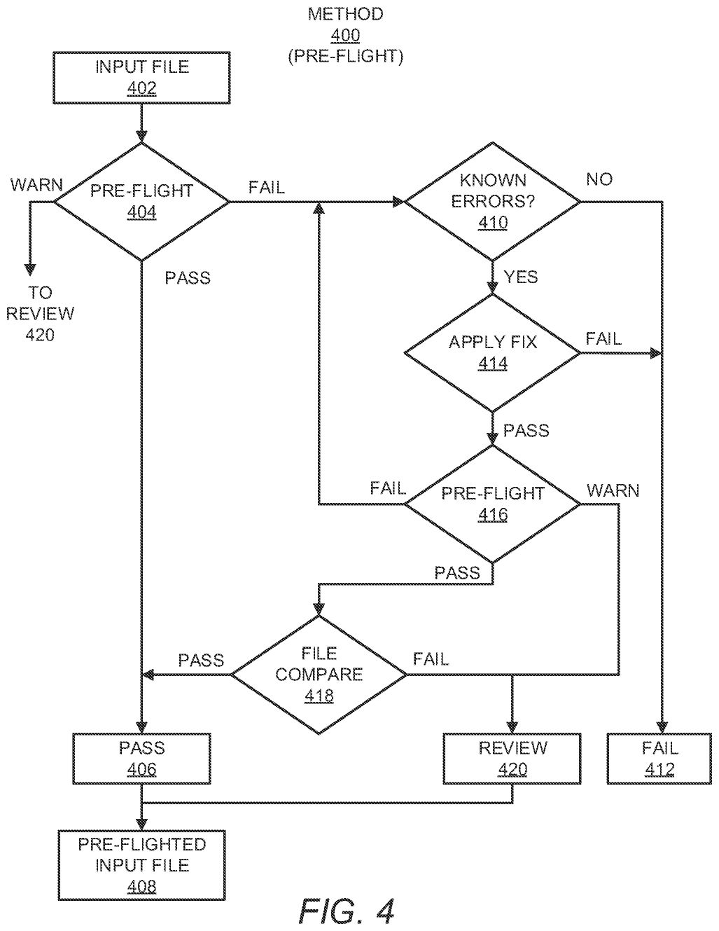

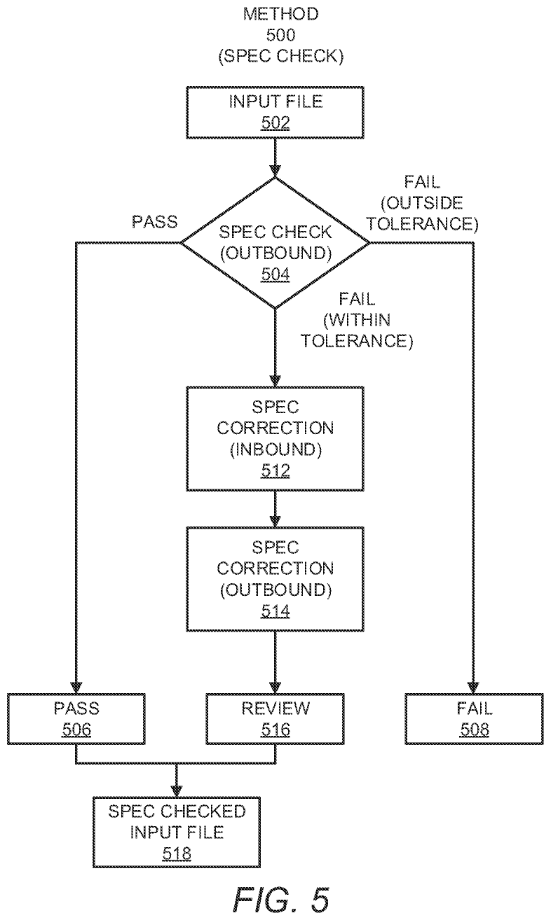

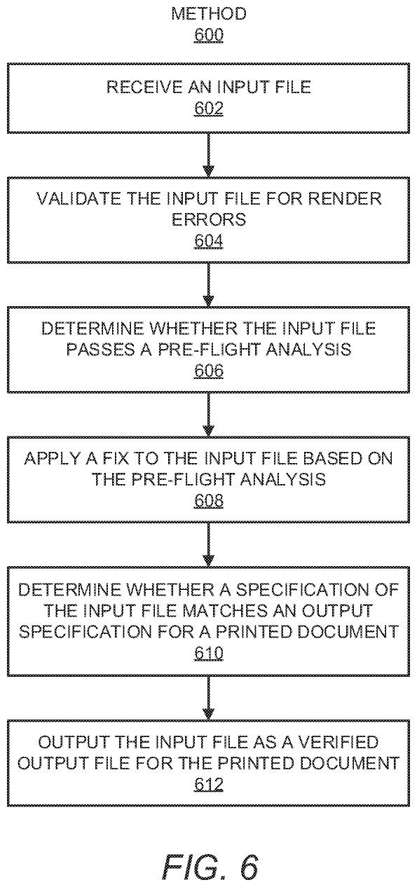

Various manners in which the processor 102 may operate are discussed in greater detail with respect to the methods 300, 400, 500, and 600 respectively depicted in FIGS. 3, 4, 5, and 6. FIG. 3 depicts a flow diagram of an example method for performing file validation for an input file, which may include performing error detection, re-distillation, and re-validation of the input file. FIG. 4 depicts a flow diagram of an example method for performing pre-flight analysis for an input file, which may include detecting errors, applying fixes based on detected errors, and verifying the fixed input file using a file compare. FIG. 5 depicts a flow diagram of an example method for performing a specification check for an input file, which may include determining whether a specification of the input file matches an output specification and correcting the specifications of the input file. FIG. 6 depicts a flow diagram of an example method for verifying an input file for a printed document, which may include validating the input file for render errors, determining whether the input file passes a pre-flight analysis, determining whether a specification of the input file matches an output specification for a printed document, and outputting the input file as a verified output file for the printed document. It should be understood that the methods 300 to 600 respectively depicted in FIGS. 3 to 6 may include additional operations and that some of the operations described therein may be removed and/or modified without departing from the scope of the methods 300 to 600. The descriptions of the methods 300 to 600 are made with reference to the features depicted in FIGS. 1 and 2 for purposes of illustration.

Referring to FIG. 3, the processor 102 may perform file validation to validate an input file for render errors. At block 302, the processor 102 may receive an input file, such as the input file 208 depicted in FIG. 2, for file validation. At block 304, the processor 102 may validate the input file 208 to identify render errors. In some examples, the render errors may include errors that may be based on a file type, a structure of a file format, a predetermined rule or criteria such as whether the input file 208 is able to be opened and worked on, and/or the like. At block 308, based on identification of certain errors, such as a determination that the input file 208 is an invalid file type, for instance that the input file 208 is an unsupported file type, the processor 102 may output an indication that the file validation has failed.

At block 306, the processor 102 may determine whether the identified render errors are recoverable errors. At block 310, the processor 102 may re-distill the input file 208 to convert the input file 208 from a PostScript format to a PDF format. At black 312, the processor 102 may re-validate the re-distilled input file 208 for the render errors.

At block 314, based on a determination that the re-distilled input file being successfully re-validated to not include the render errors, the processor 102 may perform a complexity check to determine whether a complexity of the contents of the input file 208 is below a predetermined threshold. In some examples, the complexity check may include a determination of an amount of time to rasterize the input file 208, for instance, based on a complexity of the input file 208 due to a number of different fonts used in the input file 208.

At block 316, the processor 102 may determine whether the input file 208 has been re-distilled, and based on a determination that the input file 208 has been re-distilled, at block 322, the processor 102 may output an indication, such as the first indication 210 having a review condition to recommend human review of the re-distilled input file 208. Based on a determination that the input file 208 has not been re-distilled, at block 318, the processor may output an indication, such as the first indication 210 having a pass condition. At block 320, the processor 102 may output a validated input file 208.

Referring to FIG. 4, the processor 102 may perform pre-flight analysis on an input file. At block 402, the processor 102 may receive the input file, which may be the same as the input file 208 depicted in FIG. 2. In some examples, the input file may be the validated input file 208 that is output after a successful file validation at block 320.

At block 404, the processor 102 may perform a pre-flight analysis on the input file 208. During pre-flight analysis, the processor 102 may confirm whether data for printing processes are all present, valid, correctly formatted, of the correct type, and/or the like, in order to prepare the digital files for downstream printing processes. In some examples, during the pre-flight analysis, the processor 102 may confirm and verify colors, fonts, transparency layers, image resolutions, PDF versions, and/or the like, of the input file 208.

At block 406, based on the pre-flight analysis at block 404 passing, the processor 102 may output an indication, such as the second indication 214 depicted in FIG. 2, to indicate a pass condition. At block 410, however, based on pre-flight analysis at block 404 failing, the processor 102 may determine whether any of the detected pre-flight errors are known errors. In some examples, the pre-flight analysis may correlate with a predetermined file format profile and the known errors for the file format profile may have correlated fixes to address the known errors.

At block 414, the processor 102 may apply a fix to the input file 208 based on the determined known errors identified during the pre-flight analysis. Continuing with the example in which the input file 208 is a PDF file, the processor 102 may determine during the pre-flight analysis that certain fonts embedded in the PDF file do not match a pre-flight profile associated with the pre-flight analysis, and in some examples, the processor 102 may apply a fix to correct the fonts in the PDF file.

At block 416, the processor 102 may determine whether the input file 208 that includes the fix passes a second pre-flight analysis. In some examples, the pre-flight analysis initially applied to the input file 208 at block 404 and the second pre-flight analysis of block 416 may be based on the same file format profile, such as a specific PDF profile. In some examples, the processor 102 may iteratively apply fixes for different render errors and respective pre-flight analysis a predetermined number of iterations until the input file 208 passes the pre-flight analysis, or the processor 102 may exit the pre-flight analysis should the pre-flight analysis fail after a predetermined number of iterations.

At block 418, based on a determination that the input file 208 has passed the second pre-flight analysis, the processor 102 may perform a file comparison between the input file 208 with the applied fix and the input file 208 without the fix. In some examples, the processor 102 may convert pages of the input file 208 into images. The processor 102 may compare the image of the input file 208 based on a pixel-by-pixel comparison between an image in the input file 208 that includes the fix and an image in the input file 208 without the fix. In some examples, the pixel-by-pixel comparison may be performed at a predetermined pixel resolution, for instance, at a one pixel resolution, or the like. At block 420, based on a determination that the input file 208 has passed the second pre-flight analysis at block 416 but with certain conditions, the processor 102 may output an indication, such as the second indication 214 with a review condition to alert a user to review the fixed input file 208.

At block 406, based on a determination that the image in the input file 208 that includes the fix matches the image in the input file 208 without the fix, the processor 102 may output the second indication 214 including the condition 216 to indicate a pass condition. At block 408, the processor 102 may output the input file 208 as a pre-flighted input file. Based on a determination that the input file 208 has failed the file comparison, the processor 102 may output the indication to alert the user to manually review the fixed input file 208, at block 420.

Referring to FIG. 5, the processor 102 may perform a specification check on an input file. At block 502, the processor 102 may receive the input file, which may be the same as the input file 208 depicted in FIG. 2. In some examples, the input file 208 may be the pre-flighted input file that is output after a successful pre-flight analysis, at block 408.

At block 504, the processor 102 may determine whether specifications of the input file 208 matches an output specification, or outbound specifications, for a printed document. At block 506, based on a determination that the input file 208 has passed the specification check, the processor 102 may generate an indication, such as the third indication 218 depicted in FIG. 2, which may include a pass condition. At block 508, based on a determination that the input file 208 has failed the specification check, the processor 102 may output the third indication 218, which may include a fail condition.

At block 512, based on a determination that the specifications of the input file 208 are within a predetermined tolerance of the inbound specifications, the processor 102 may apply a correction to the input file 208 based on the inbound specifications. At block 514, the processor 102 may apply a correction to the input file 208 based on the outbound specifications of the printed document.

In some examples, the inbound specifications for the input file 208 and the outbound specifications for the printed document may correlate to parameters for a shape, a size, and/or the like. In some examples, the processor 102 may determine whether a shape and/or a size of the input file 208 matches the output specification for the printed document. In some examples, at block 512, the processor 102 may adjust the shape and/or the size of the input file 208 based on the inbound specifications, which may be obtained from metadata of the input file 208. Based on a determination that the shape and/or a size of the input file 208 does not match the output specification for the printed document, at block 514, the processor 102 may adjust the shape and/or the size of the input file 208 to match the output specification based on a determination that the shape and/or a size of the input file 208 does not match the output specification for the printed document. At block 516, the processor 102 may output an indication, such as the third indication 218 depicted in FIG. 2 with a review condition, to recommend a user review of the specification checked input file 208.

At block 518, the processor 102 may output the input file 208 as a specification checked input file. In some examples, the specification checked input file may be the same as the verified output file 222 for the printed document depicted in FIG. 2.

Referring to FIG. 6, the processor 102 may verify an input file for a printed document, which may include file validation, pre-flighting, and specification checking, to output the input file as a verified output file for a printed document. At block 602, the processor 102 may receive an input file to be verified for a printing process, such as the input file 208 depicted in FIG. 2. In some examples, the input file 208 may have a predetermined format, such as a PDF format.

At block 604, the processor 102 may validate the input file 208 for render errors. In some examples, the file validation may include a determination of whether the input file is able to be opened. At block 606, the processor 102 may determine whether the input file passes a pre-flight analysis. At block 608, the processor 102 may apply a fix to the input file based on the pre-flight analysis.

At block 610, based on a determination that the input file 208 has passed the pre-flight analysis, the processor 102 may determine whether a specification of the input file 208 matches an output specification for a printed document. In some examples, the output specification may include parameters for a shape, a size, and/or the like, of the printed document.

At block 612, based on a determination that the specification of the input file 208 corresponds to the output specification, the processor 102 may output the input file 208 as a verified output file for the printed document, such as the verified output file 222 depicted in FIG. 2.

In some examples, based on a determination that a render error for the input file 208 exists, the processor 102 may re-distill the input file 208 to convert the input file 208 from a first document format, such as a PostScript format to a second document format, such as a PDF format.

In some examples, the processor 102 may re-validate the re-distilled input file 208 for the render errors. In some examples, based on the re-distilled input file 208 being successfully re-validated to not include the render errors, the processor 102 may output the re-validated input file 208 for the pre-flight analysis, such as the input file in block 402. In some examples, based on the re-distilled input file 208 not being successfully re-validated, the processor 102 may output an indication for the input file 208, such as the first indication 210 depicted in FIG. 2. The output indication may include an error message and/or an indication to a user to review the input file 208.

In some examples, based on a determination that the input file 208 has not passed the pre-flight analysis, the processor 102 may iteratively apply fixes selected from a plurality of predetermined fixes and may perform the pre-flight analysis a predetermined number of times. In some examples, the pre-flight analysis may be correlated to a predetermined file format profile, such as a PDF profile.

In some examples, based on a determination that the input file 208 has passed the pre-flight analysis, the processor 102 may process a pixel-by-pixel comparison between an image in the input file 208 that may include the fixes and an image in the input file 208 without the fixes. In some examples, the input file 208 for specification comparison may be a pre-flighted input file, such as the pre-flighted input file at block 408. Based on a determination that the image in the input file 208 that includes the fix matches the image in the input file 208 without the fix, the processor 102 may output the input file 208 to perform the specification check, for instance, to determine whether the specification of the input file 208 matches the output specification for the printed document.

In some examples, the processor 102 may determine whether a shape, a size, and/or the like, of the input file 208 matches the output specification. The processor 102 may adjust the shape and/or the size of the input file 208 based on a determination that the shape and/or a size of the input file 208 does not match the output specification.

Some or all of the operations set forth in the method 600 may be included as utilities, programs, or subprograms, in any desired computer accessible medium. In addition, the method 600 may be embodied by computer programs, which may exist in a variety of forms both active and inactive. For example, they may exist as computer-readable instructions, including source code, object code, executable code or other formats. Any of the above may be embodied on a non-transitory computer-readable storage medium.

Examples of non-transitory computer-readable storage media include computer system RAM, ROM, EPROM, EEPROM, and magnetic or optical disks or tapes. It is therefore to be understood that any electronic device capable of executing the above-described functions may perform those functions enumerated above.

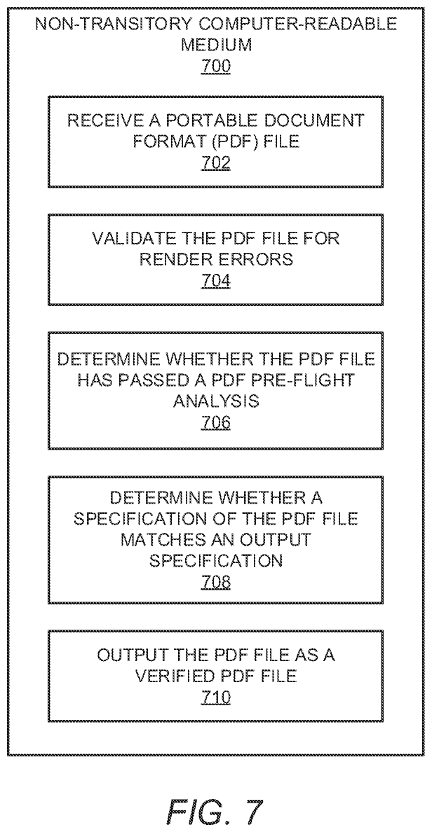

Turning now to FIG. 7, there is shown a block diagram of a non-transitory computer-readable medium 700 that may have stored thereon computer-readable instructions to verify a PDF file to output a verified PDF file, to validate the PDF file for render errors, determine whether the PDF file passes a PDF pre-flight analysis, and determine whether a specification of the PDF file matches an output specification. It should be understood that the computer-readable medium 700 depicted in FIG. 7 may include additional instructions and that some of the instructions described herein may be removed and/or modified without departing from the scope of the computer-readable medium 700 disclosed herein. The computer-readable medium 700 may be a non-transitory computer-readable medium. The term “non-transitory” does not encompass transitory propagating signals.

The computer-readable medium 700 may have stored thereon computer-readable instructions 702-710 that a processor, such as the processor 102 depicted in FIGS. 1 and 2, may execute. The computer-readable medium 700 may be an electronic, magnetic, optical, or other physical storage device that contains or stores executable instructions. The computer-readable medium 700 may be, for example, Random-Access memory (RAM), an Electrically Erasable Programmable Read-Only Memory (EEPROM), a storage device, an optical disc, or the like.

The processor may fetch, decode, and execute the instructions 702 to receive a PDF file. The PDF file may be the same as the input file 208 depicted in FIG. 2. The processor may fetch, decode, and execute the instructions 704 to validate the PDF file for render errors. In some examples, the validation of the PDF file may include a determination of whether the PDF file can be opened and worked upon.

The processor may fetch, decode, and execute the instructions 706 to determine whether the PDF file has passed a PDF pre-flight analysis. The processor may fetch, decode, and execute the instructions 708 to determine, based on a determination that the PDF file has passed the PDF pre-flight analysis, whether a specification of the PDF file matches an output specification. The processor may fetch, decode, and execute the instructions 710 to output the PDF file as a verified PDF file based on a determination that the specification of the PDF file corresponds to the output specification.

In some examples, based on a determination that the validation of the PDF file includes render errors, the processor may re-distill the PDF file based on the render errors, and may re-validate the re-distilled PDF file for the render errors. Based on the re-distilled PDF file being successfully re-validated to not include the render errors, the processor may output the re-validated PDF file for the PDF pre-flight analysis. In some examples, based on the re-distilled PDF file not being successfully re-validated, the processor may output an indication for the PDF file. The output indication may include an error message, an indication to a user to review the PDF file, and/or the like.

In some examples, based on a determination that the PDF file has failed the PDF pre-flight analysis, the processor may apply a fix to the PDF file based on the PDF pre-flight analysis. The PDF pre-flight analysis may be correlated to a predetermined PDF format profile. In some examples, the processor may determine whether the PDF file that includes the fix has passed a second PDF pre-flight analysis.

Based on a determination that the PDF file has passed the second PDF pre-flight analysis, the processor may perform a file comparison, which may include a pixel-by-pixel comparison between an image in the PDF file that includes the fix and an image in the PDF file without the fix. Based on a determination that the image in the PDF file that includes the fix matches the image in the PDF file without the fix, the processor may output the PDF file to determine whether the specification of the PDF file matches the output specification.

In some examples, in order to perform the file comparison, the processor may determine whether a shape, a size, and/or the like, of the PDF file matches the output specification. The processor may adjust the shape and/or the size of the PDF file based on a determination that the shape and/or a size of the PDF file does not match the output specification.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which are stored machine-readable instructions that when executed by the processor, cause the processor to:
receive an input file;
validate the input file for render errors;
based on a determination that the input file does not include the render errors, determine whether the input file passes a pre-flight analysis;
based on a determination that the input file has passed the pre-flight analysis, determine whether a specification of the input file matches an output specification for a printed document; and
based on a determination that the specification of the input file corresponds to the output specification, output the input file as a verified output file for the printed document.

2. The apparatus of claim 1, wherein the validation of the input file for render errors includes a determination of whether the input file is able to be opened.

3. The apparatus of claim 1, wherein the instructions cause the processor to:
based on a determination that a render error for the input file exists, re-distill the input file to convert the input file from a PostScript format to a portable document format (PDF).

4. The apparatus of claim 3, wherein the instructions cause the processor to:
re-validate the re-distilled input file for the render errors; and
one of:
based on the re-distilled input file being successfully re-validated to not include the render errors, output the re-validated input file for the pre-flight analysis; or
based on the re-distilled input file not being successfully re-validated, output an indication for the input file, the output indication including an error message and/or an indication to a user to review the input file.

5. The apparatus of claim 1, wherein the instructions cause the processor to:
based on a result of the validation of the input file for render errors, output a first indication that indicates a pass, a fail, or a review condition for validation of the input file for the render errors;
based on a result of the pre-flight analysis, output a second indication that indicates a pass, a fail, or a review condition for the pre-flight analysis of the input file; and
based on a result of the determined specification of the input file, generate a third indication that indicates a pass, a fail, or a review condition for the specification of the input file.

6. The apparatus of claim 1, wherein the instructions cause the processor to:
based on a determination that the input file has failed the pre-flight analysis, apply a fix to the input file based on the pre-flight analysis, the pre-flight analysis being correlated to a predetermined file format profile; and
determine whether the input file that includes the fix passes a second pre-flight analysis.

7. The apparatus of claim 6, wherein the instructions cause the processor to:
based on a determination that the input file has passed the second pre-flight analysis, perform a pixel-by-pixel comparison between an image in the input file that includes the fix and an image in the input file without the fix; and
based on a determination that the image in the input file that includes the fix matches the image in the input file without the fix, output the input file to determine whether the specification of the input file matches the output specification for the printed document.

8. The apparatus of claim 6, wherein the pre-flight analysis and the second pre-flight analysis are based on a portable document format (PDF) profile.

9. The apparatus of claim 1, wherein the instructions cause the processor to:
determine whether a shape and/or a size of the input file matches the output specification; and
adjust the shape and/or the size of the input file based on a determination that the shape and/or a size of the input file does not match the output specification.

10. A method comprising:
receiving, by a processor, an input file;
validating, by the processor, the input file for render errors, the validation including a determination of whether the input file is able to be opened;
determining, by the processor, whether the input file passes a pre-flight analysis;
applying, by the processor, a fix to the input file based on the pre-flight analysis;
based on a determination that the input file has passed the pre-flight analysis, determining, by the processor, whether a specification of the input file matches an output specification for a printed document, the output specification including a shape and/or a size of the printed document; and
based on a determination that the specification of the input file corresponds to the output specification, outputting, by the processor, the input file as a verified output file for the printed document.

11. The method of claim 10, further comprising:
based on a determination that a render error for the input file exists, re-distilling the input file to convert the input file from a PostScript format to a portable document format (PDF).

12. The method of claim 11, further comprising:
re-validating the re-distilled input file for the render errors; and
one of:
based on the re-distilled input file being successfully re-validated to not include the render errors, outputting the re-validated input file for the pre-flight analysis; or
based on the re-distilled input file not being successfully re-validated, outputting an indication for the input file, the output indication including an error message and/or an indication to a user to review the input file.

13. The method of claim 10, further comprising:
based on a determination that the input file has not passed the pre-flight analysis, iteratively applying fixes selected from a plurality of predetermined fixes and performing the pre-flight analysis a predetermined number of times, the pre-flight analysis being correlated to a predetermined file format profile.

14. The method of claim 13, further comprising:
based on a determination that the input file has passed the pre-flight analysis, performing a pixel-by-pixel comparison between an image in the input file that includes the fixes and an image in the input file without the fixes; and
based on a determination that the image in the input file that includes the fix matches the image in the input file without the fix, outputting the input file to determine whether the specification of the input file matches the output specification for the printed document.

15. The method of claim 10, further comprising:
determining whether a shape and/or a size of the input file matches the output specification; and
adjusting the shape and/or the size of the input file based on a determination that the shape and/or a size of the input file does not match the output specification.

16. A non-transitory computer-readable medium on which is stored machine-readable instructions that, when executed by a processor, cause the processor to:
receive a portable document format (PDF) file;
validate the PDF file for render errors, the validation of the PDF file including a determination of whether the PDF file is able to be opened;
determine whether the PDF file has passed a PDF pre-flight analysis;
based on a determination that the PDF file has passed the PDF pre-flight analysis, determine whether a specification of the PDF file matches an output specification; and
based on a determination that the specification of the PDF file corresponds to the output specification, output the PDF file as a verified PDF file.

17. The non-transitory computer-readable medium of claim 16, wherein the instructions cause the processor to:
based on a determination that the validation of the PDF file includes render errors:
re-distill the PDF file based on the render errors; and
re-validate the re-distilled PDF file for the render errors; and
based on the re-distilled PDF file being successfully re-validated to not include the render errors, output the re-validated PDF file for the PDF pre-flight analysis; or
based on the re-distilled PDF file not being successfully re-validated, output an indication for the PDF file, the output indication including an error message and/or an indication to a user to review the PDF file.

18. The non-transitory computer-readable medium of claim 16, wherein the instructions cause the processor to:
based on a determination that the PDF file has failed the PDF pre-flight analysis, apply a fix to the PDF file based on the PDF pre-flight analysis, the PDF pre-flight analysis being correlated to a predetermined PDF format profile; and
determine whether the PDF file that includes the fix has passed a second PDF pre-flight analysis.

19. The non-transitory computer-readable medium of claim 18, wherein the instructions cause the processor to:
based on a determination that the PDF file has passed the second PDF pre-flight analysis, perform a pixel-by-pixel comparison between an image in the PDF file that includes the fix and an image in the PDF file without the fix; and
based on a determination that the image in the PDF file that includes the fix matches the image in the PDF file without the fix, output the PDF file to determine whether the specification of the PDF file matches the output specification.

20. The non-transitory computer-readable medium of claim 16, wherein the instructions cause the processor to:
determine whether a shape and/or a size of the PDF file matches the output specification; and
adjust the shape and/or the size of the PDF file based on a determination that the shape and/or a size of the PDF file does not match the output specification.
